(19) United States
(12) Patent Application Publication
(10) Pub. No.: US 2009/0095441 A1
(43) Pub. Date: Apr. 16, 2009

(54) CONSTRUCTION VEHICLE

(75) Inventors: Yasuhiro Masunoya, Ishikawa (JP); Shigeo Hashimoto, Ishikawa (JP)

Correspondence Address: GLOBAL IP COUNSELORS, LLP, 1233 20TH STREET, NW, SUITE 700, WASHINGTON, DC, 20036-2680, US

(73) Assignee: KOMATSU LTD., Minato-ku, Tokyo (JP)

(21) Appl. No.: 12/093,346

(22) PCT Filed: Dec. 4, 2006
(86) PCT No.: PCT/JP2006/324153

§ 371 Date: May 12, 2008

(30) Foreign Application Priority Data
Dec. 19, 2005 (JP) 2005-365297

(51) Int. Cl. B60K 11/04

(52) U.S. Cl. 165/41; 180/68.4

(57) ABSTRACT

A construction vehicle includes vehicle frames, an operator cab, a hydraulic oil tank, and engine, and an engine cover. The operator cab is mounted on the vehicle frames. The hydraulic oil tank is disposed to the rear of the operator cab and stores hydraulic oil. The engine is disposed to the rear of the hydraulic oil tank. The engine cover is a member that covers the engine. A rear face of the hydraulic oil tank and a front face of the engine cover are the same size in a widthwise direction. A rear end of an upper face of the hydraulic oil tank is positioned at the same height as a front end of the upper face of the engine cover. The upper face and side faces of the hydraulic oil tank are exposed to outside.

### CROSS-REFERENCE TO RELATED APPLICATIONS

This U.S. National stage application claims priority under 35 U.S.C. §119(a) to Japanese Patent Application No. 2005-365297, filed in Japan on Dec. 19, 2005. The entire disclosure of Japanese Patent Application No. 2005-365297 is hereby incorporated herein by reference.

### TECHNICAL FIELD

The present invention relates to a construction vehicle.

### BACKGROUND ART

A hydraulic oil tank for storing hydraulic oil such as hydraulic oil supplied to a hydraulic oil pump is provided at a construction vehicle. This hydraulic oil tank is provided in the vicinity of a side end of a vehicle frame. For example, in a construction vehicle disclosed in Japanese Patent Application Laid-open No. 2002-97666, a hydraulic oil tank is provided in the vicinity of a side end of a vehicle frame on a working equipment side. A battery storage case is disposed to the front of the hydraulic oil tank and an engine room is disposed to the rear of the hydraulic oil tank.

### DISCLOSURE OF INVENTION

With the construction vehicle described above, an upper face and one side face of the hydraulic oil tank are exposed to outside but other portions of the hydraulic oil tank are covered by the working equipment, battery storage case, and engine room etc. The surface area exposed to the outside is therefore small. There is therefore the fear that the effect of cooling of hydraulic oil stored in the hydraulic oil tank will be diminished.

The object of the present invention is therefore to provide a construction vehicle where the extent by which hydraulic oil stored in the hydraulic oil tank is cooled is increased.

The construction vehicle of a first aspect of the invention includes a vehicle frame, an operator cab, a hydraulic oil tank, an engine, and an engine cover. The operator cab is mounted on the vehicle frame. The hydraulic oil tank is disposed to the rear of the operator cab and stores hydraulic oil. The engine is disposed to the rear of the hydraulic oil tank. The engine cover is a member that covers the engine. The rear face of the hydraulic oil tank and the front face of the engine cover are the same size in the widthwise direction, and the rear end of a upper face of the hydraulic oil tank is positioned at the same height as the front end of a upper face of the engine cover. The upper face and both side faces of the hydraulic oil tank are exposed to outside.

At the construction vehicle, the upper face and both of the side faces of the hydraulic oil tank are exposed to outside. The surface area of the hydraulic oil tank that is exposed to outside is therefore large. It is therefore possible to increase the extent by which hydraulic oil stored in the hydraulic oil tank is cooled. Further, there is the feature that degradation of the external appearance could lower attractiveness when the exposure of the hydraulic oil tank to outside becomes substantial. However, with this construction vehicle, the rear face of the hydraulic oil tank and the front face of the engine cover are the same size in a widthwise direction and the rear end of the upper face of the hydraulic oil tank is positioned at the same height as the front end of the upper face of the engine cover. As a result, the upper face and both of the side faces of the hydraulic oil tank exposed to outside are flush with the upper face and both of the side faces of the engine cover disposed to the rear. There is therefore little detriment to the external appearance. As a result, with this construction vehicle, it is possible to increase the extent to which hydraulic oil stored in the hydraulic oil tank is cooled and degradation of the external appearance is suppressed.

The construction vehicle of a second aspect of the invention is the construction vehicle of the first aspect of the invention with the hydraulic oil tank disposed on a center axis in a widthwise direction of the vehicle frame.

The hydraulic oil tank is a portion that stores hydraulic oil and is therefore comparatively heavy. The weight is therefore unevenly distributed when the hydraulic oil tank is only provided in the vicinity of a side end of the vehicle frame as with conventional construction vehicles.

However, with this construction vehicle, it is possible to reduce uneven distribution of weight using the hydraulic oil tank by disposing the hydraulic oil tank on a center axis in a widthwise direction of the vehicle frame. As a result, it is possible to improve weight balance with this construction vehicle.

The construction vehicle of a third aspect of the invention is the construction vehicle of the second aspect of the invention with the center of the hydraulic oil tank in a widthwise direction positioned on a center axis in a widthwise direction of the vehicle frame.

It is possible to improve the balance of weight with this construction vehicle by positioning the center of the hydraulic oil tank in a widthwise direction on a center axis in a widthwise direction of the vehicle frame.

The construction vehicle of a fourth aspect of the invention is the construction vehicle of the third aspect of the invention with the hydraulic oil tank having an inlet port that hydraulic oil flowing out from the hydraulic oil tank passes through and a strainer that covers the inlet port. The strainer is positioned on a center axis in a widthwise direction of the vehicle frame.

With this construction vehicle, the strainer is positioned on a center axis in a widthwise direction of the vehicle frame. Inclination of the vehicle frame while taking in hydraulic oil from the strainer therefore has little effect. It is therefore possible to stably provide hydraulic oil from the hydraulic oil tank with this construction vehicle.

The construction vehicle of a fifth aspect of the invention is the construction vehicle of the first aspect of the invention further comprising a hydraulic oil piping unit that hydraulic oil flowing out from the hydraulic oil tank and flowing into the hydraulic oil tank passes through. This hydraulic oil piping passes within the vehicle frame and is connected to the lower face, front face, or rear face of the hydraulic oil tank.

With this construction vehicle, the hydraulic oil piping unit passes within the vehicle frame and is connected to the lower face, front face, or rear face of the hydraulic oil tank. On the other hand, the operator cab is disposed to the front of the hydraulic oil tank and the engine cover is disposed to the rear of the hydraulic oil tank. The hydraulic oil piping connected to the hydraulic oil tank therefore does not degrade the external appearance and it is possible to improve attractiveness.

The construction vehicle of a sixth aspect of the invention is the construction vehicle of any one of the first to fifth aspects of the invention further including a radiator and air conditioning equipment. The radiator is disposed to the rear of the engine, and is apparatus for cooling the engine. The air conditioning equipment has an air conditioning equipment body and a condenser for performing air conditioning (provide conditioned air) within the operator cab. The air conditioning equipment body is disposed to the front of the operator cab. The condenser is disposed to the front of the radiator.

With construction vehicles of the related art, the arrangement of air conditioning equipment in space to the rear of the operator cab is common. This restricts the installation space and makes arrangement of the hydraulic oil tank to the rear of the operator cab difficult. There is also the fear that portions to the rear of the operator cab will become large even when arrangement of the hydraulic oil tank to the rear of the operator cab is possible.

However, with this construction vehicle, the air conditioning equipment body is disposed to the front of the operator cab and the condenser is disposed to the front of the radiator. It is therefore possible to suppress increases in size of portions to the rear of the operator cab and disposing of the hydraulic oil tank to the rear of the operator cab is possible.

### BRIEF DESCRIPTION OF THE DRAWINGS

FIG. 1 is a left side view of a construction vehicle.

FIG. 2 is a perspective view of the construction vehicle from the rear right.

FIG. 3 is a cross-section of a hydraulic oil tank (viewed from the front).

FIG. 4 is a perspective view showing an engine cover with a side cover open.

FIG. 5 is a perspective view showing a structure for a left door section, a right side step, and a left bar.

FIG. 6 is a plan view showing a positional relationship for a left door section, a left side step, and a left bar.

FIG. 7 is a left side view showing a positional relationship for a side cover and a first bar.

FIG. 8 is a plan view showing a positional relationship for the side cover and the first bar.

### BEST MODE FOR CARRYING OUT THE INVENTION

### Structure

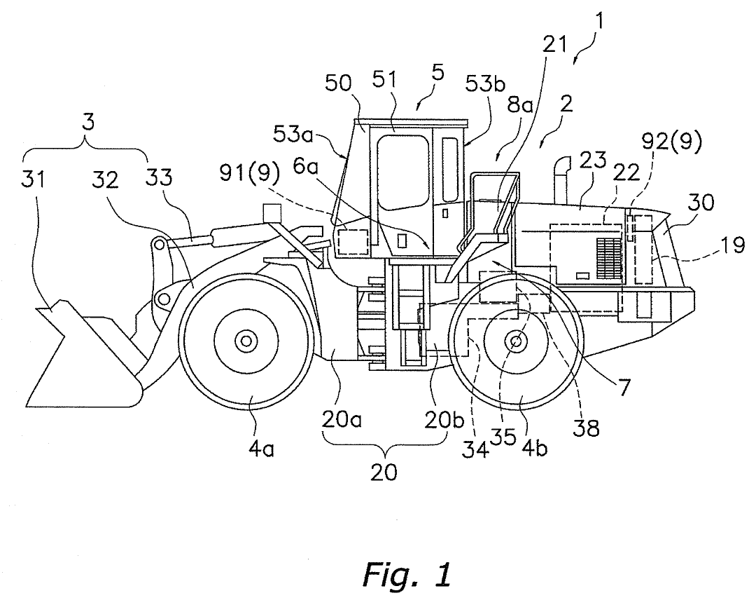

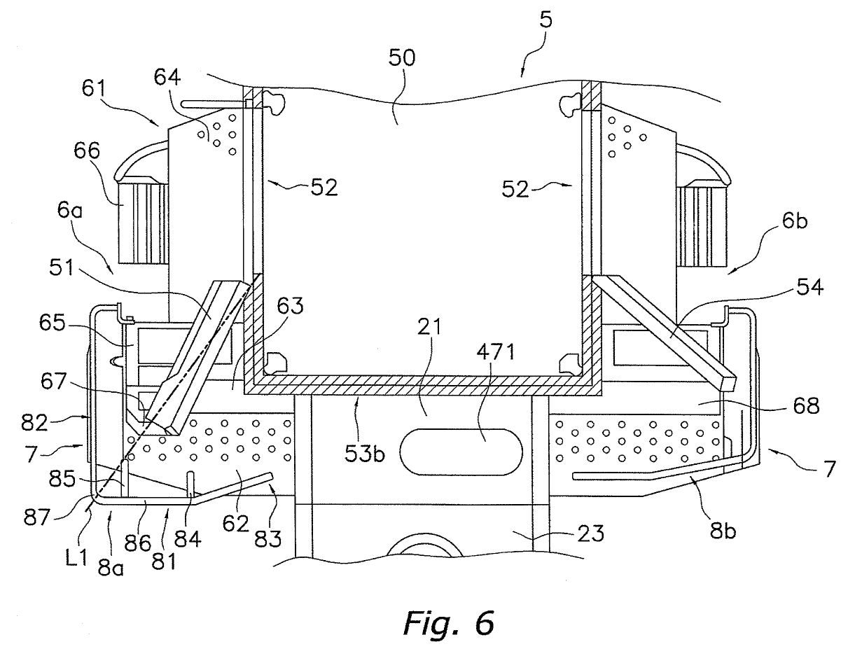

A left side view of a construction vehicle 1 of an embodiment of the present invention is shown in FIG. 1. This construction vehicle 1 is a wheel loader that is capable of propelling itself using the tires 4a, 4b and is capable of carrying out desired operations using working equipment 3. The construction vehicle 1 mainly includes a vehicle body 2, the tires 4a, 4b, the working equipment 3, a operator cab 5, an air conditioning equipment 9, side steps 6a, 6b (refer to FIG. 6), a fender 7, and bars 8a, 8b (refer to FIG. 6).

### Vehicle Body 2

The vehicle body 2 has a vehicle frame 20, a hydraulic oil tank 21, an engine 22, a transmission 34, a torque converter 38, a hydraulic oil pump 35, and an engine cover 23, etc.

### Vehicle Frame 20

The vehicle frame 20 has a front frame 20a disposed to the front side, and a rear frame 20b disposed to the rear side. The front frame 20a and the rear frame 20b are coupled in a manner enabling rocking in a lateral direction at a center part of the vehicle frame 20. The working equipment 3 is fitted to the front frame 20a and drive equipment such as the engine 22, the torque converter 38, and the transmission 34 etc. and the hydraulic oil pump 35 are mounted on the rear frame 20b.

### Hydraulic Oil Tank 21

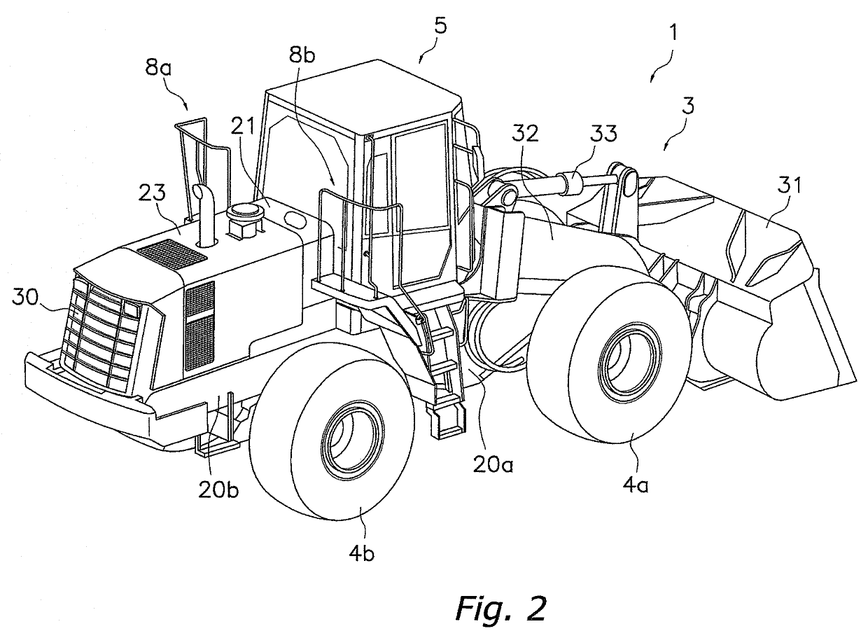

The hydraulic oil tank 21 internally stores hydraulic oil subjected to pressure by the hydraulic oil pump 35 and is disposed to the rear of the operator cab 5. An upper face of the hydraulic oil tank 21 is positioned lower than an upper face of the operator cab 5 and is positioned lower than upper ends of the bars 8a, 8b. The rear end of the upper face of the hydraulic oil tank 21 is positioned at the same height as the front end of the upper face of the engine cover 23. Further, as shown in FIG. 2, the hydraulic oil tank 21 is smaller in a widthwise direction than the operator cab 5 and the rear face of the hydraulic oil tank 21 and the front face of the engine cover 23 are the same size in a widthwise direction. The outer face of the hydraulic oil tank 21 is therefore flush with the outer face of the engine cover 23. Namely, the side face and upper face of the hydraulic oil tank 21 are flush with the side face and the upper face of the engine cover 23. Further, an external cover covering the hydraulic oil tank 21 therefore does not have to be provided and the outer face of the hydraulic oil tank 21 is therefore exposed to outside. Here, “flush” means that there are no substantial steps at the boundary of the hydraulic oil tank 21 and the engine cover 23 with the contours being roughly continuous, and the boundaries not necessarily have to be smooth faces with no joints. The presence of a step at part of the boundary of the hydraulic oil tank 21 and the engine cover 23 is possible.

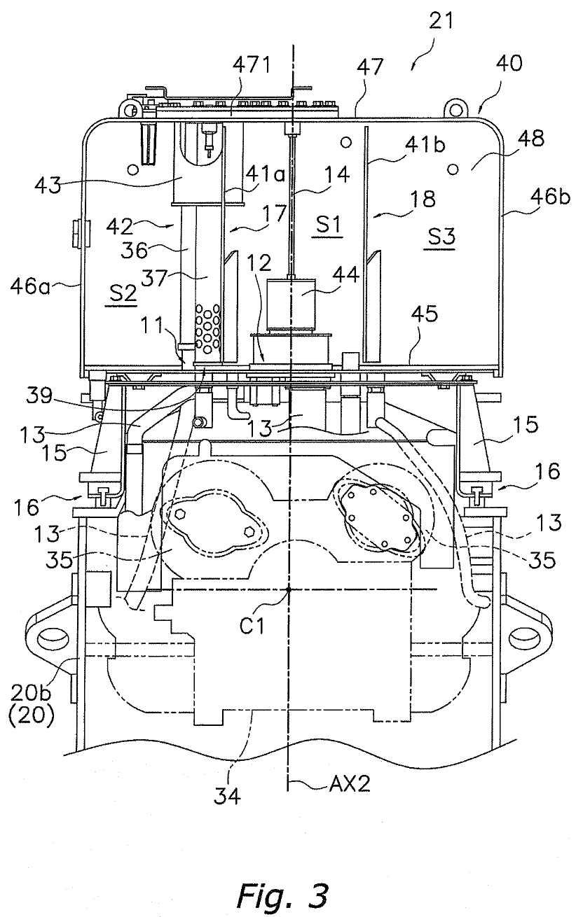

FIG. 3 shows a cross-sectional view of the hydraulic oil tank 21. FIG. 3 is a cross-sectional view of the hydraulic oil tank 21 as viewed from the front. The hydraulic oil tank 21 has a tank body 40, partitions 41a, 41b, a hydraulic oil guide pipe 42, a filter 43, and a strainer 44, etc.

The tank body 40 is a box-shaped member formed from metal plates, and has a bottom plate 45, side plates 46a, 46b, top plate 47, front plate (not shown) and rear plate 48.

The bottom plate 45 constitutes a lower face of the tank body 40 and is disposed in a substantially horizontal manner. The bottom plate 45 is arranged on the rear frame 20b via mounting legs 15. The bottom plate 45 is fitted to the rear frame 20b via mounts 16. A return port 11 hydraulic oil returning to the hydraulic oil tank 21 passes through and an inlet port 12 hydraulic oil flowing out from the hydraulic oil tank 21 passes through are provided at the bottom plate 45. Hydraulic oil piping 13 arranged within the vehicle frame 20 that fluid flowing out from the hydraulic oil tank 21 and fluid flowing into the hydraulic oil tank 21 passes through is also connected to the bottom plate 45.

The side plates 46a, 46b constitute side faces of the tank body 40 and are provided substantially perpendicularly with regards to the bottom plate 45. The side plates 46a, 46b are a right side plate 46a and a left side plate 46b, and are connected with a right side end and a left side end of the bottom plate 45.

In this embodiment, “right” and “left” mean “right” and “left” as viewed from the front (bucket 31 side) of the operator cab 5.

The top plate 47 constitutes the upper face of the tank body 40 and is provided in a substantially horizontal manner. A cover 471 is fixed using bolts to the top plate 47 and the filter 43 and one end of a strainer rod 14 are fitted to the inner face of the cover 471.

The front plate constitutes the front face of the tank body 40 and is provided substantially perpendicularly with respect to the bottom plate 45. The front plate is connected to the front end of the bottom plate 45, front end of the side plates 46a, 46b, and the front end of the top plate 47 and faces towards the rear face of the operator cab 5.

The rear plate 48 constitutes the rear face of the tank body 40 and is provided substantially perpendicularly with respect to the bottom plate 45. The rear plate 48 is connected to the rear end of the bottom plate 45, the rear ends of the side plates 46a, 46b and the rear end of the top plate 47 and faces the front face of the engine cover 23.

Further, the tank body 40 is disposed on a center axis AX2 in a widthwise direction of the vehicle frame 20 and the center in a widthwise direction of the tank body 40 is positioned on a center axis AX2 in a widthwise direction of the vehicle frame 20. The center axis AX2 in a widthwise direction of the vehicle frame 20 passes through a center C1 of a crankshaft of the engine 22, and the center in a widthwise direction of the tank body 40 is positioned on a vertical line passing through a center C1 of a crankshaft as viewed from the front.

The partitions 41a, 41b are disposed substantially parallel with respect to the side plates 46a, 46b and partition the inside of the tank body 40 into a number of spaces. The front ends of the partitions 41a, 41b are connected to the front plate, and the rear ends are connected to the rear plate 48. The partitions 41a, 41b are a first partition 41a and a second partition 41b, with the first partition 41a and the second partition 41b being disposed spaced from each other in a widthwise direction. The first partition 41a partitions a first space S1 at a center and a second space S2 on the right side of the first space S1, The second partition 41b partitions the first space S1 and a third space S3 on the left side of the first space S1. Large openings 17, 18 are provided at the upper half of the first partition 41a and the second partition 41b so that the first space S1 and the second space S2 communicate, and the first space S1 and the third space S3 communicate.

The hydraulic oil guide pipe 42 is provided within the tank body 40 and is a pipe that hydraulic oil returning to the hydraulic oil tank 21 passes through. The hydraulic oil guide pipe 42 has a first pipe section 36 and a second pipe section 37. A lower end of the first pipe section 36 is connected to the return port 11 of the bottom plate 45 and an upper end is connected to the filter 43. An upper end of the second pipe section 37 is connected to the filter 43 and a discharge opening 39 that discharges hydraulic oil is provided at a lower end. This discharge opening 39 is disposed in the vicinity of the bottom plate 45 in the vicinity of the first partition 41a within the second space S2.

The filter 43 is fitted to the inner face of the top plate 47 and cleans hydraulic oil returning to the hydraulic oil tank 21. The filter 43 is provided midway along the hydraulic oil guide pipe 42 as described above and cleans hydraulic oil passing through the hydraulic oil guide pipe 42.

The strainer 44 is fitted to the inner face of the bottom plate 45 so as to cover the inlet port 12 and cleans hydraulic oil taken in at the inlet port 12. A lower end of the strainer rod 14 is fitted to the upper face of the strainer 44 and the strainer 44 is pushed against the bottom face by the strainer rod 14. The upper end of the strainer rod 14 is fitted to the inner face of the top plate 47. The strainer 44 is provided at the first space S1 and is disposed on the center axis AX2 in a widthwise direction of the vehicle frame 20. The strainer 44 is cylindrical and a center axis of the strainer 44 and the strainer rod 14 as viewed from the front are positioned on the center axis AX2 in a widthwise direction of the vehicle frame 20.

Engine 22, transmission 34, torque converter 38, hydraulic oil pump 35

The engine 22 is a diesel engine. Output torque generated by the engine 22 is distributed at the transmission 34 and the hydraulic oil pump 35 and constitutes drive power when driving the working equipment 3 and when the construction vehicle 1 travels. The engine 22 is supported by the rear frame 20b and is disposed to the rear of the hydraulic oil tank 21.

The transmission 34 and the torque converter 38 are disposed to the front of the engine 22, and transmit drive power generated by the engine 22 to the tires 4a, 4b.

The hydraulic oil pump 35 is a variable capacity hydraulic oil pump 35 driven by output of the engine 22 and is disposed to the front of the engine 22 below the hydraulic oil tank 21.

Engine Cover 23

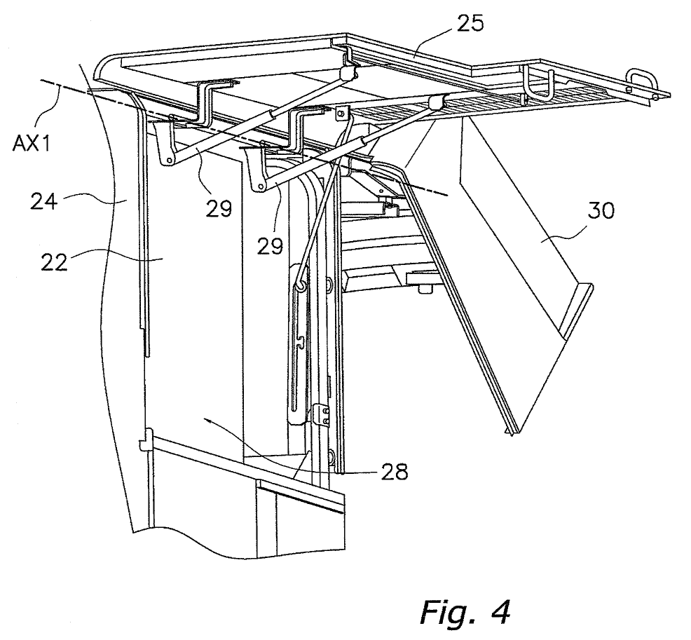

The engine cover 23 is a member covering the engine 22 and is disposed to the rear of the hydraulic oil tank 21. As shown in FIG. 4, the engine cover 23 has an engine cover body 24 and a pair of side covers 25.

The engine cover body 24 is formed from metal plates and is a member covering the engine 22. An opening 28 is provided at a position, of the side faces of the engine cover body 24, facing the engine 22. The opening 28 is provided at both side faces of the engine cover body 24. As shown in FIG. 1, the upper face of the engine cover body 24 is inclined slightly so that a rear side is positioned downwards, and the front end is substantially flush with the rear end of the upper face of the hydraulic oil tank 21. Further, the front end of the side face of the engine cover body 24 is also substantially flush with the rear ends of the side faces of the hydraulic oil tank 21.

The pair of side covers 25 are provided on both sides of the engine cover body 24 and can close the opening 28 of the side faces of the engine cover body 24. The side cover 25 for a left side face is shown in FIG. 4. The side covers 25 can open and close the opening 28 of the engine cover body 24 as a result of centrally rotating hinges provided at the upper ends of the pair of side covers 25. The upper ends of the pair of side covers 25 reach the upper face of the engine cover body 24 and are inclined with rear sides positioned downwards as with the upper face of the engine cover body 24. The pair of side covers 25 can therefore be rotated and moved centrally about a rotating axis AX1 with a rear side extending in a longitudinal direction being inclined downwards. The side covers 25 are supported by support means 29 of gas springs etc. provided within the engine cover body 24 and can be fixed at opening angles for two stages. A first stage is a state of opening at an angle smaller than 90 degrees of, for example, thirty to forty-five degrees. A second stage is the state shown in FIG. 4 and is a state of opening at ninety degrees. In this second state, the side covers 25 are substantially parallel with a horizontal face, and are positioned at substantially the same height as the upper face of the engine cover body 24.

A radiator 19 (refer to FIG. 1) and a cooling fan (not shown) for cooling the engine 22 are disposed to the rear of the engine 22 and a freely opening and closing rear cover 30 that covers the cooling fan and the radiator 19 are provided at the rear face of the engine cover 23.

### Tires 4a, 4b

The tires 4a, 4b include a pair of front tires 4a provided at the front frame 20a and a pair of rear tires 4b provided at the rear frame 20b giving a total of four tires disposed at sides of lower part of the vehicle body 2. The front tires 4a disposed at the sides of lower part of the front frame 20a are positioned at a front part of the front frame 20a. The rear tires are provided at the sides of lower part of the rear frame 20b and are positioned at a central portion of the rear frame 20b in a direction from front to rear. The rear tires 4b are provided further to the rear than the operator cab 5. The tires 4a and 4b are driven at the time of traveling as a result of drive power transmitted by the engine 22 via the torque converter 38, transmission 34, and drive shaft (not shown).

### Working Equipment 3

The working equipment 3 is a mechanism driven by hydraulic oil pressurized by the hydraulic oil pump 35 and has a lift arm 32 fitted to a front part of the vehicle body 2, a bucket 31 fitted to the end of this lift arm 32, a bucket cylinder 33, and an arm cylinder (not shown). The lift arm 32 is a member for lifting the bucket 31 fitted to its end. The bucket 31 is fitted to the end of the lift arm 32. The bucket cylinder 33 and the arm cylinder are hydraulic oil actuators that drive the bucket 31 and the lift arm 32 using pressurized oil discharged from the hydraulic oil pump 35.

### Operator Cab 5

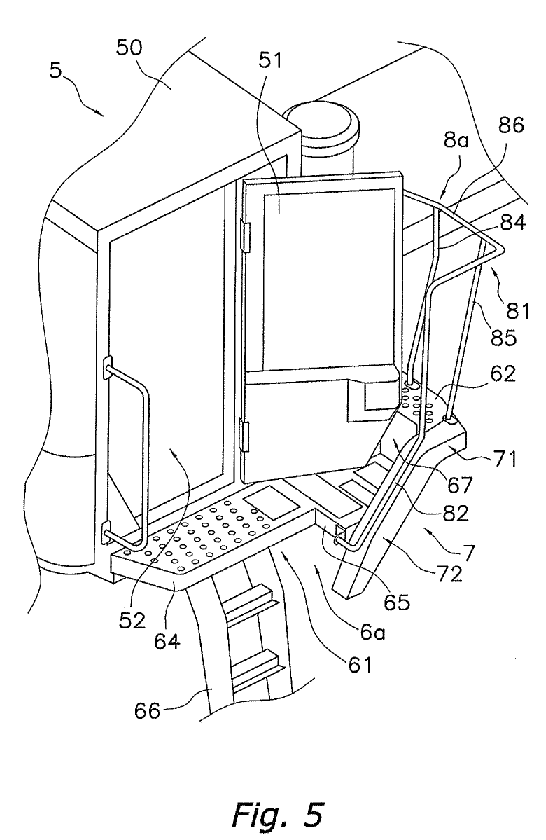

The operator cab 5 is mounted at an upper part of the vehicle body 2 and, as shown in FIG. 5 and FIG. 6, has an operator cab body 50, a left door section 51 and a right door section 54.

The operator cab body 50 is constructed by combining a number of steel pipes and steep plates and is substantially in the shape of a rectangular solid. Openings 52 enabling an operator to enter and exit are provided on both side faces of the operator cab body 50 and windows 53a, 53b (refer to FIG. 1) are provided at the front face and rear face of the operator cab body 50. The operator cab body 50 is mounted on the front part of the rear frame 20b and is positioned between the front tires 4a and the rear tires 4b in a direction from front to rear. The operator cab body 50 is positioned to the front of the hydraulic oil tank 21 and is larger in a widthwise direction than the hydraulic oil tank 21. A seat, operation units such as a steering wheel, and a display unit that displays various information such as speed are built into the operator cab body 50.

The left door section 51 is provided at the left side face of the operator cab body 50 and an opening 52 of the left side face of the operator cab body 50 can be opened and closed by central rotation about a hinge provided at a rear end. The left door section 51 can be opened up to an angle of approximately one hundred and fifty degrees and can be opened to a greater angle than the right door section 54, as shown in FIG. 5 and FIG. 6.

The right door section 54 is provided at the right side face of the operator cab body 50 and can be rotated centering about a hinge provided at a rear end, as with the left door section 51. The right door section 54 can be opened up to an angle of approximately one hundred and thirty-five degrees.

### Air Conditioning Equipment 9

The air conditioning equipment 9 shown in FIG. 1 is equipment for carrying out air conditioning within the operator cab 5 by carrying out thermal exchange between a cooling agent and air. The air conditioning equipment 9 has an air conditioning equipment body 91 and a condenser 92. The air conditioning equipment body 91 has a compressor and heat exchanger etc., and is disposed at a storage space at a front lower part of the operator cab 5. The condenser 92 is disposed distanced from the air conditioning equipment body 91 and is electrically connected to the air conditioning equipment body 91 using a cable. The condenser 92 has a thin, plate-shaped external shape and is disposed to the front of the radiator 19.

### Side Steps 6a, 6b and Fender 7

The side steps 6a, 6b shown in FIG. 5 and FIG. 6 are provided along from the side of the operator cab body 50 to the rear of the operator cab 5 and constitute footholds for the operator to get on and off the operator cab body 50. The side steps 6a, 6b, are constituted by a left side step 6a provided at the left side of the operator cab body 50 and a right side step 6b provided at the right side of the operator cab body 50. The left side step 6a and the right side step 6b are provided symmetrically so as to sandwich the operator cab body 50 therebetween.

The left side step 6a has a first step section 61 positioned at the side of the opening 52 of the operator cab body 50, a second step section 62 positioned to the rear of the first step section 61 above the first step, and a stepped section 63 connecting the first step section 61 and the second step section 62.

The first step section 61 is provided in a longitudinal direction along the opening 52 of the operator cab body 50 and has a substantially horizontal upper face. The first step section 61 has a front section 64 that is smaller in a widthwise direction than the fender 7 described later, and a rear section 65, connected to a rear end of the front section 64, that is wider in a widthwise direction than the front section 64. The front section 64 is provided in a longitudinal direction from a front end of a side face of the operator cab body 50 to a position where a hinge for the left door section 51 is provided, i.e. to a position slightly to the rear of a rear end of the opening 52. A ladder section 66 extending downwards from the lower face of the front section 64 is provided at a side end of the front section 64. The rear section 65 is provided in a longitudinal direction from the vicinity of a hinge of the left door section 51 to the rear end of the left side face of the operator cab body 50. Arrangement is such that the fender 7 overlaps in the vicinity of the rear end of the left side face of the operator cab body 50 when viewed from the side. However, an internal portion of the fender 7 is formed so as to be collapsible to the rear and the rear section 65 is then disposed at this collapsible portion.

The second step section 62 is provided at an upper face of the fender 7 and is substantially horizontal. The second step section 62 is positioned above the first step section 61 and is positioned to the rear of the rear section 65 of the first step section 61. The second step section 62 is provided from the left side face of the hydraulic oil tank 21 provided to the rear of the operator cab body 50 to the left side end of the rear section 65. The right side end of the second step section 62 is then positioned to the rear of the operator cab body 50 because the hydraulic oil tank 21 is smaller in a widthwise direction than the operator cab body 50. The rear end of the second step section 62 is given an inclined shape so as to be positioned to the front, i.e. further to the outside than the left side end side.

The stepped section 63 connects the rear end of the first step section 61 and the front end of the second step section 62 and is assembled on the first step section 61. A recess 67 recessed in a direction towards the rear is provided in the vicinity of the left side end of the stepped section 63. The position where the recess 67 is provided is a position the end of the left door section 51 collides with when fully open.

The right side step 6b has substantially the same structure as the left side step 6a but a recess such as the recess 67 of the left side step 6a is not provided for a stepped section 68 of the right side step 6b.

The fender 7 is a member that covers the rear tires 4b in order to prevent dirt from splashing up from the rear tires 4b. The fenders 7 are provided on both sides of the vehicle body 2 and project sideways from the sides of the vehicle body 2. The fenders are formed not to completely cover above the rear tires 4b but rather to cover only the upper front side of the rear tires 4b. As shown in FIG. 5, the fender 7 has a horizontal section 71 with an upper face provided substantially horizontally and an inclined section 72 inclined so that a front side is positioned downwards when viewed from the side. The second step section 62 described above is provided on the upper face of the horizontal section 71. The rear end of the inclined section 72 is connected to the front end of the horizontal section 71 and the rear section 65 and the stepped section 63 described above are provided at the inside of the inclined section 72.

### Bars 8a, 8b

The bars 8a, 8b are members for preventing falling off of the side steps 6a, 6b and are assembled on the upper side face of the fender 7. A left bar 8a provided on the fender 7 on the left side and a right bar 8b (refer to FIG. 6) provided on the fender 7 on the right side are the bars 8a, 8b.

The left bar 8a has a first bar 81 provided on the upper face of the horizontal section 71 of the fender 7, i.e. on the second step section 62, and a second bar 82 provided on the upper side face of the inclined section 72.

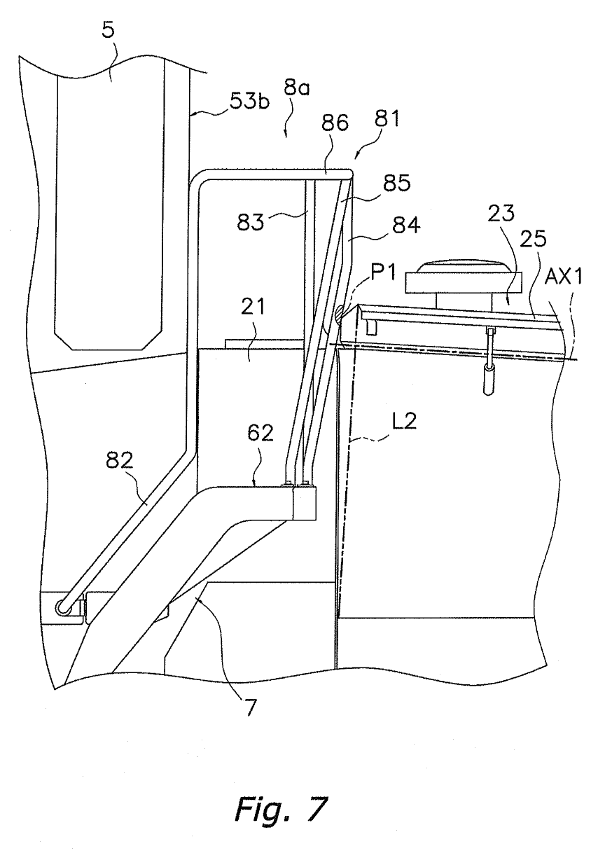

The first bar 81 is provided behind the rear end of the left door section 51 in a completely open state along to the rear end of the second step section 62. The first bar 81 has a first column 83, a second column 84, a third column 85, and a hand rail 86 linking the upper ends of the first column 83, the second column 84 and the third column 85. The first column 83, the second column 84, and the third column 85 are disposed in order spaced in a widthwise direction along to the rear end of the second step section 62, and the first column 83 is disposed to the rightmost side, i.e. at the side of the hydraulic oil tank 21. As shown in FIG. 7, the first column 83 is a straight pipe member parallel with a vertical direction. The second column 84 and the third column 85 are positioned to the outside of the first column 83, i.e. to the left of the first column 83. The second column 84 and the third column 85 have upper ends inclined to the rear. The lower end of the second column 84 is therefore at the same position as the first column 83 when viewed from the side and therefore overlap in a longitudinal direction. However, the upper end of the second column 84 is positioned further to the rear than the upper end of the first column 83. Further, the lower end of the third column 85 is positioned further to the front than the second column 84 and the first column 83 in a longitudinal direction. However, the upper end of the third column 85 is positioned further to the rear than the upper end of the first column 83 and is positioned at the same position as the upper end of the second column 84. The upper end of the second column 84 and the upper end of the third column 85 are positioned further to the rear than the rear end of the second step section 62 and are positioned further to the rear than the rear end of the fender 7.

The second bar 82 is positioned to the side of the end of the left door section 51 when completely open and is provided along the side end of the left side step 6a on the left side step 6a. More specifically, the second bar 82 is provided along the upper side face of the inclined section 72 of the fender 7 and the left side end of the upper face of the horizontal section 71. As shown in FIG. 6, when viewed from above, the second bar 82 makes an angle of substantially ninety degrees with the first bar 81, and the rear end of the second bar 82 is connected to the left side end of the hand rail 86 of the first bar 81.

The right bar 8b has a similar structure to the left bar 8a but differs from the left bar 8a in that all of a number of columns provided along the rear end of the right side step 6b are in the shape of a straight line parallel with a vertical direction.

### Positional Relationship of the Left Door Section 51 and the Left Bar 8a

Next, a detailed description is given based on FIG. 6 of the positional relationship of the left door section 51 and the left bar 8a that is a feature of the invention of this application.

The left door section 51 can be opened as far as a virtual line L1 linking a bent section 87 linking the first bar 81 and the second bar 82 and a hinge of the left door section 51. When the left door section 51 is opened as far as possible, the end of the left door section 51 is adjacent to or is positioned on the virtual line L1 linking the bent section 87 and the hinge of the left door section 51. In this state, an end of the left door section 51 collides with the recess 67 and opening beyond this point is not possible.

Further, in the above state, a space of an order capable of allowing an operator to pass is maintained between the end of the left door section 51 and the second bar 82. Moreover, the end of the left door section 51 is positioned to the front between the second column 84 and the third column 85 of the first bar 81. However, a gap of an order capable of allowing an operator to pass is ensured between the end of the left door section 51 and the first bar 81 as a result of the second column 84 and the third column 85 being inclined to the rear.

The end of the left door section 51 is adjacent to the second bar 82 in a state where the left door section 51 is open to ninety degrees or to slightly more than ninety degrees. In this state, a slight gap is maintained between the end of the left door section 51 and the second bar 82. The left door section 51 can therefore be opened without interfering with the second bar 82 or the fender 7 as was the case with items where the operator could not pass.

### Positional Relationship of the Side Cover 25 and the First Bar 81

Next, a detailed description is given based on FIG. 7 of the positional relationship of the side cover 25 and the first bar 81.

The second step section 62 is positioned to the left side of the hydraulic oil tank 21 further to the front than the engine cover 23. A moveable space that moves during opening and closing of the side cover 25 is therefore positioned to the rear of the first bar 81 provided on the second step section 62. There is therefore the fear that the first bar 81 will interfere with the side cover 25 when the extent of inclination to the rear of the first bar 81 is substantial. The positional relationship of side cover 25 and the first bar 81 is therefore as described in the following in order to prevent interference between the side cover 25 and the first bar 81 at the construction vehicle 1.

As with the upper face of the engine cover body 24, rotating axis AX1 of the side cover 25 is inclined so that the rear side is positioned downwards. When the side cover 25 is then rotated, the front end of the side cover 25 moves along a locus L2 (refer to dotted and dashed line of FIG. 7) inclined so that the upper end side is positioned to the rear when viewed from the side. The inclination of the locus L2 of the front end of the side cover 25 is in the same direction as the inclination of the second column 84 and the third column 85 of the first bar 81 and interference between the side cover 25 and the first bar 81 therefore becomes difficult.

The portion P1 facing the side cover 25 in an open state of the first bar 81 is positioned at the same position as the front end of the pair of side covers 25 in a closed state or slightly to the rear, in a longitudinal direction. Namely, the front end of the side cover 25 is positioned in such a manner that there is interference when moved in a vertical direction. However, when the portion P1 of the first bar 81 facing the side covers 25 moves along the locus L2 and a completely open state is reached, the portion P1 is positioned to the front from the front end of the over 25 and a gap is ensured with the side cover 25. The first bar 81 can therefore be positioned as far as possible to the rear within a range where there is no interference with the side cover 25.

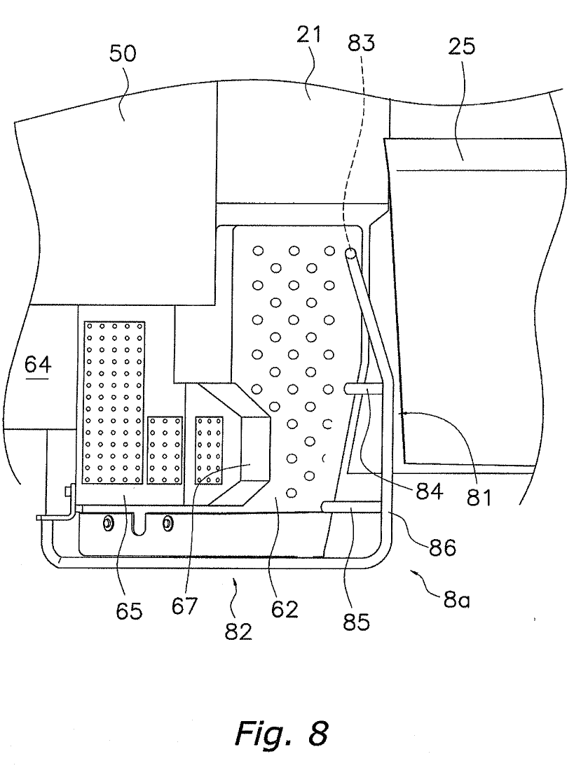

Further, as shown in FIG. 8, the front end of the side cover 25 is inclined so as to be positioned further to the rear than the end side of the side cover 25 as viewed from above in a state where the side cover 25 is completely opened. Namely, the portion of the front end of the side cover 25 facing the second column 84 and the third column 85 is positioned comparatively to the rear. This means that interference with the front end of the side cover 25 is difficult even if the second column 84 and the third column 85 are inclined to the rear. The portion, of the front end of the side cover 25, facing the first column 83 is positioned comparatively to the front but the first column 83 is not shaped so as to be inclined to the rear and interference is therefore avoided.

(1) With this construction vehicle 1 there is no externally fitted cover that covers the hydraulic oil tank 21. Moreover, the upper face and side faces of the hydraulic oil tank 21 are exposed to outside because the hydraulic oil tank 21 is disposed between the operator cab 5 and the engine cover 23. The extent to which the hydraulic oil is cooled can therefore be increased. It is also possible for the effects of cooling to be substantially increased during travel because the construction vehicle 1 is a wheel loader capable of high-speed travel.

(2) With this construction vehicle, the upper face and side faces of the hydraulic oil tank 21 are provided flush with the upper face and the side faces of the engine cover 23 disposed to the rear. The external faces of the hydraulic oil tank 21 and the engine cover 23 are therefore flush with each other. This means that degradation of the external appearance is small even if the upper face and side faces of the hydraulic oil tank 21 are exposed to the outside. This suppresses lowering of overall attractiveness.

An externally fitting cover that covers the hydraulic oil tank 21 is not provided with this construction vehicle 1 and the external faces of the hydraulic oil tank 21 therefore also constitute the exterior. Increases in the number of parts can therefore be suppressed and manufacturing costs can be reduced.

(3) With this construction vehicle 1, the hydraulic oil tank 21 is loaded on the vehicle frame 20 with the center in the widthwise direction of the hydraulic oil tank 21 positioned on the center axis AX2 in a widthwise direction of the vehicle frame 20. Weight distribution is therefore improved.

(4) With this construction vehicle 1, it is possible to connect the hydraulic oil piping 13 disposed within the vehicle frame 20 to the lower face of the hydraulic oil tank 21 without being exposed to outside because the hydraulic oil tank 21 is mounted on the vehicle frame 20. The attractiveness of the construction vehicle 1 can therefore be improved because the hydraulic oil piping 13 does not affect the external appearance.

(5) At the construction vehicle 1, of the parts of the air conditioning equipment 9, the comparatively large condenser 92 is disposed to the front of the radiator 19 spaced away from the air conditioning equipment body 91. The air conditioning equipment body 91 is disposed at a storage space at a front lower part of the operator cab 5. It is therefore possible to keep the external shape from becoming large and to dispose the hydraulic oil tank 21 to the rear of the operator cab 5.

(6) With this construction vehicle 1, the strainer 44 disposed within the hydraulic oil tank 21 is positioned on the center axis AX2 in a widthwise direction of the vehicle frame 20. It is then possible to suppress the detrimental influence of hydraulic oil being taken in from the strainer 44 when the vehicle frame 20 is inclined. It is therefore possible to stably provide hydraulic oil from the hydraulic oil tank 21 with this construction vehicle 1.

### FURTHER EMBODIMENTS

(1) In the above embodiment, the hydraulic oil piping 13 is connected to the lower face of the hydraulic oil tank 21. However, it is also possible to provide the hydraulic oil piping 13 without degrading the external appearance of the construction vehicle 1 even when connected to the front face or the rear face of the hydraulic oil tank 21.

(2) In the above embodiments, the invention of this application is applied to a wheel loader but is also applicable to other construction vehicles. However, the effects of cooling the hydraulic oil are more substantial in the case of application to wheel loaders capable of high-speed travel.

The invention of this application is capable of increasing the effect of cooling hydraulic oil stored in a hydraulic oil tank and suppressing degradation of attractiveness and is therefore useful for construction vehicles.

1. A construction vehicle comprising:
a vehicle frame;
an operator cab mounted on the vehicle frame;
a hydraulic oil tank disposed to the rear of the operator cab to store hydraulic oil;
an engine disposed to the rear of the hydraulic oil tank; and
an engine cover that covers the engine,
wherein a rear face of the hydraulic oil tank and a front face of the engine cover are the same size in a widthwise direction,
a rear end of an upper face of the hydraulic oil tank is positioned at the same height as a front end of an upper face of the engine cover, and
the upper face and both side faces of the hydraulic oil tank are exposed to outside.

2. The construction vehicle according to claim 1, wherein
the hydraulic oil tank is disposed on a center axis line in a widthwise direction of the vehicle frame.

3. The construction vehicle according to claim 2, wherein
a center of the hydraulic oil tank in the widthwise direction is positioned on the center axis in the widthwise direction of the vehicle frame.

4. The construction vehicle according to claim 3, wherein the hydraulic oil tank includes
an inlet port through which hydraulic oil flowing out from the hydraulic oil tank passes, and
a strainer that covers the inlet port, the strainer being positioned on the center axis in the widthwise direction of the vehicle frame.

5. The construction vehicle according to claim 1, further comprising
a hydraulic oil piping unit passing within the vehicle frame and connected to a lower face, a front face, or a rear face of the hydraulic oil tank so that hydraulic oil flowing out from the hydraulic oil tank or flowing into the hydraulic oil tank passes through the hydraulic oil piping unit.

6. The construction vehicle according to claim 1 5, further comprising
a radiator disposed to the rear of the engine to cool the engine; and
air conditioning equipment having an air conditioning equipment body and a condenser to provide conditioned air within the operator cab with the air conditioning equipment body being disposed to the front of the operator cab and the condenser being disposed to the front of the radiator.
